(19) United States
(12) Patent Application Publication
(10) Pub. No.: US 2006/0053608 A1
(43) Pub. Date: Mar. 16, 2006

(54) Pipe disassembling tool

(76) Inventor: Pi-Liang Wu, Taichung (TW)

Correspondence Address: PI-LIANG WU, P.O. BOX 55-124, TAICHUNG, TW

(21) Appl. No.: 11/196,336

(22) Filed: Aug. 4, 2005

(30) Foreign Application Priority Data
Sep. 14, 2004 (TW) 093214624

(51) Int. Cl. B23P 19/04

(52) U.S. Cl. 29/237

(57) ABSTRACT

A pipe disassembling tool includes a U-shaped body having a first arm and a second arm that can be outwardly wrenched relative to each other. The first arm and the second arm respectively have a curved cutout defined in a free end thereof and facing each other. A first curved pusher and a second covered pusher respectively extends from the free end of the first arm and the second arm. Each curved pusher corresponds to a corresponding one of the two curved cutouts. The first curved pusher and the second curved pusher are provided to outwardly the pawls of a coupling to allow the operator longitudinally detaching the pipe.

### BACKGROUND OF THE INVENTION

1. Field of the Invention

The present invention relates to a disassembling tool, and more particularly to a pipe disassembling tool.

2. Description of Related Art

As well known, a vehicle usually uses pipes to cycle engine oil for lubricating the engine to ensure the engine being operated in a smooth condition. An oil filter is provided to filter the impurities from the used oil for preventing the elements in the engine from being damaged due to the impurities in the used oil. With reference to FIGS. 1 and 2, the oil filter (1) includes two nozzles (102) respectively longitudinally extending from two opposite ends thereof. Each nozzle (102) has an annular groove (104) defined therein near a free end of each of the nozzles (102). A pipe (2) is longitudinally connected to a corresponding one of the two nozzles (102) and has a connecting tube (202) partially inserted into a connecting end of the pipe (2). A coupling (3) is disposed on a connecting end of the pipe (2) for connecting to the nozzle (102) and a free end of the connecting tube (202) is inserted into the nozzle (102) for communicating the pipe (2) with the nozzle (102). A buckle (4) is mounted in the coupling (3) for engaging to the nozzle (102) and made of resilient material. The buckle (4) has a skirt (402) secured received in an inner periphery of the coupling (3), and multiple pawls (404) inwardly and obliquely extending from the skirt (402). Each pawl (404) has a free end engaged into the annular groove (104) to prevent the pipe (2) from being reversely detached from the nozzle (102) when the coupling (3) is sleeved on the nozzle (102) and the connecting tube (202) is inserted into the nozzle (102).

However, the assembled pipe (2) frequently needs to be replaced when being broken. In addition, the assembled pipe (2) needs to be detached from the nozzle (102) when the oil filter (1) needs to be replaced. The pawls (404) must be disengaged from the annular groove (104). The pawls (404) may be broken when the pipe (2) is detached from the nozzle (102) by force before the pawls (404) be disengaged from the annular groove (104). Consequently, a pipe disassembling tool is marketed for operator to conveniently disengage the pawls (404) from the annular groove (104).

A conventional pipe disassembling tool in accordance with the prior art shown in FIG. 3 comprises two arms (5) pivotally connected to each other. Each arm (5) includes a first end pivotally connected to each other by a pivot (7) and a second end having a curved cutout (not shown) defined in an inner side of each of the two arms (5). The two curved cutouts correspond to each other. A curved pusher (6) laterally extends from the second end of each of the two arms (5). The two curved pushers (6) correspond to each other and to a corresponding one of the two curved cutouts. When operating, the two curved pushers (6) clamp the pipe (2) and are moved toward the buckle (4) to outwardly push the pawls (404) and make the pawls (404) disengage from the annular groove (104), thereby the operator can easily pull the pipe (2) with the coupling (3) out of the nozzle (102).

However, the conventional pipe disassembling tool may not be used when the distance between the coupling (3) and the oil filter (1) is smaller than a height of the curved pusher (6) relative to the second end of each of the two arms (5).

The present invention has arisen to mitigate and/or obviate the disadvantage of the conventional pipe disassembling tool.

### SUMMARY OF THE INVENTION

The main objective of the present invention is to provide an improved pipe disassembling tool that can be conveniently operated in a small space.

To achieve the objective, the pipe disassembling tool in accordance with the present invention comprises a U-shaped body including a first arm and a second arm that can be outwardly wrenched relative to each other. Each of the first arm and the second arm has a curved cutout defined in a free end thereof and facing each other. A first curved pusher extends from the free end of the first arm and corresponds to the curved cutout in the first arm. The first curved pusher includes two curved plates perpendicularly extending from the free end of the first arm and a slit defined between the two curved plates to allow the two curved plates be elastic deformed relative to each other. A second curved pusher extends from the free end of the second arm and corresponding to the curved cutout in the second arm. The second curved pusher has a structure corresponding to that of the first curved pusher.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an oil filter and two pipes that are respectively longitudinally connected to two opposite ends of the oil filter;

FIG. 2 is a partially cross-sectional view of FIG. 1;

FIG. 3 is a perspective view of a conventional pipe disassembling tool in accordance with the prior art;

FIG. 4 is a perspective view of a pipe disassembling tool in accordance with the present invention;

FIG. 5 is a first operational view of the pipe disassembling tool in FIG. 4;

FIG. 6 is a second operational view of the pipe disassembling tool in FIG. 4;

FIG. 7 is a third operational view of the pipe disassembling tool in FIG. 4;

FIG. 8 is a perspective view of a second embodiment of the pipe disassembling tool of the present invention; and

FIG. 8A is a partially enlarged perspective view of the pipe disassembling tool in FIG. 8.

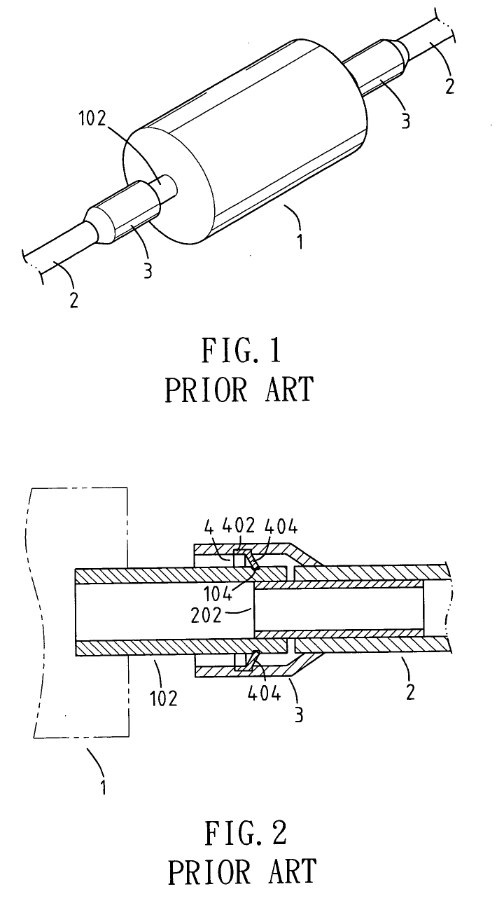

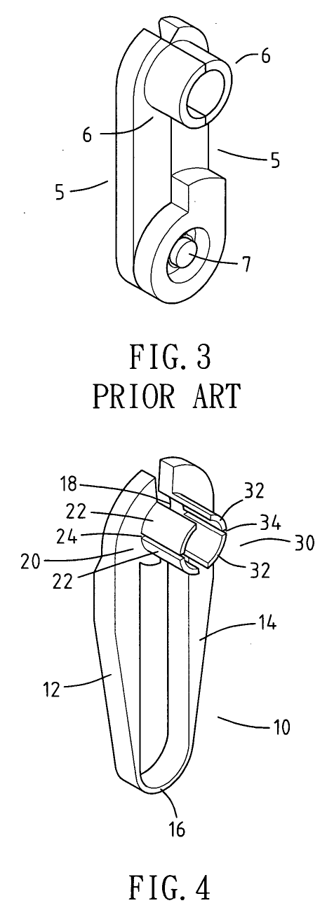

### DETAILED DESCRIPTION OF THE INVENTION

Referring to the drawings and initially to FIG. 4, a pipe disassembling tool in accordance with the present invention comprises a U-shaped body (10) having a spring portion (16) formed on a middle portion thereof to divide the U-shaped body (10) into a first arm (12) and a second arm (14). Each of the first arm (12) and the second arm (14) has a curved cutout (18) defined in a free end thereof and facing each other. The first arm (12) has a first curved pusher (20) laterally extending from the free end thereof and corresponding to the curved cutout (18). The first curved pusher (20) includes two curved plates (22) perpendicularly extending from the free end of the first arm (12) and a slit (24) is defined between the two curved plates (22) to allow the two curved plates (22) be elastic deformed relative to each other. The second arm (14) has a second curved pusher (30) that has a structure corresponding to that of the first curved pusher (20). The second curved pusher (30) includes two curved plates (32) and a slit (34) defined between the two curved plates (32) of the second curved pusher (30).

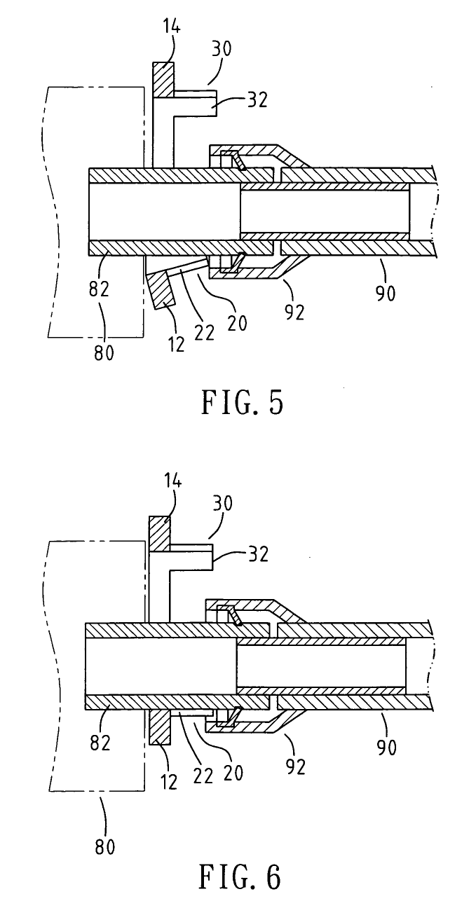

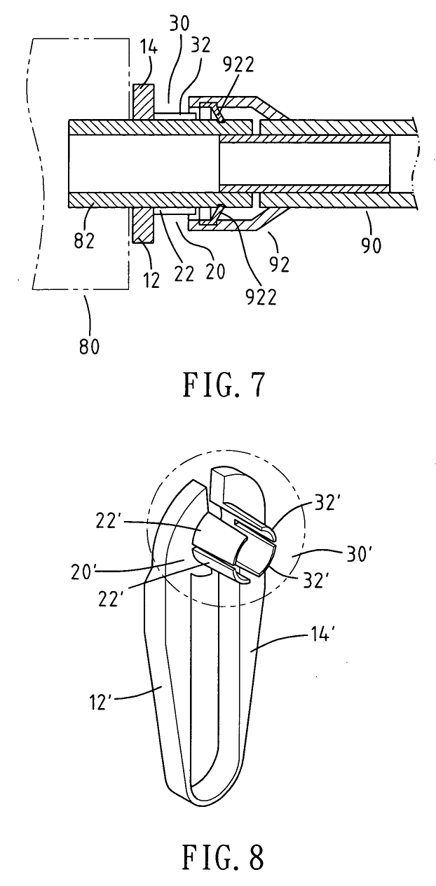

With reference to FIGS. 4-7, the structures of the oil filter (80), the pipe (90) and the coupling (92) are described in detail in Description of Related Art. However, they are re-numbered in this paragraph. As shown in FIG. 4, the distance between the oil filter (80) and the coupling (92) is smaller than a height of the curved plates (22, 32) of the first curved pusher (20) and the second curved pusher (30) such that the curved plates (22, 32) can not directly inserted into the coupling (92) for pushing the pawls (922). The U-shaped body (10) is wrenched and sprained to make the first arm (12) and the second arm (14) apart from each other. As a result, with reference to FIGS. 5 and 6, the first curved pusher (20) is obliquely inserted into the gap between the coupling (92) and the nozzle (82) due to the slit (24) and the two curved plates (22) of the first covered pusher (20) is moved toward the pawls (922). The operating method of the second curved pusher (30) is the same as that of the first curved pusher (20) and the nozzle (82) is partially received within the two curved cutouts (18) of the in the two opposite ends of the body (10). The curved plates (22, 32) of the first curved pusher (20) and the second curved pusher (30) are moved to outwardly push the pawls (922) to make the pawls (922) be disengaged from the annular groove that is defined in the nozzle (82) of the oil filter (80), thereby the operator can easily longitudinally detach the pipe (90) with the coupling (92) from the nozzle (82) of the oil filter (80).

As described above, the pipe disassembling tool in accordance with the present invention can be operated when the distance between the coupling (92) and the oil filter (80) is smaller than the height of the curved plates (22, 32) respectively relative to the first arm (12) and the second arm (14) such that obviate the disadvantage of the conventional pipe disassembling tool is obviated.

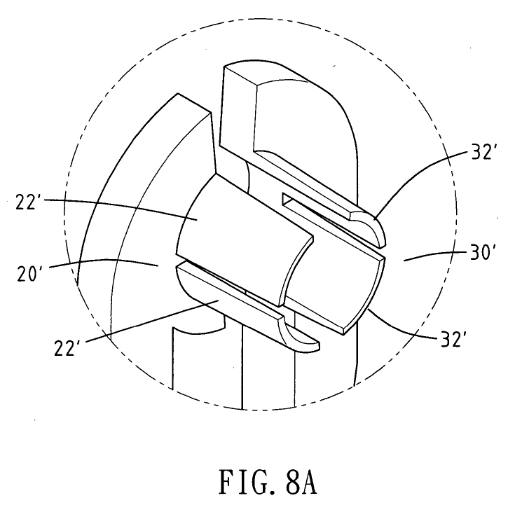

With reference to FIGS. 8 and 8A that show a second embodiment of the pipe disassembling tool in accordance with the present invention, a free end of each of the curved plates (22′, 32′) of the first curved pusher (20′) and the second curved pusher (30′) inwardly and obliquely extends such that the first curved pusher (20′) and the second curved pusher (30′) are tapered for a convenient operation.

Although the invention has been explained in relation to its preferred embodiment, it is to be understood that many other possible modifications and variations can be made without departing from the spirit and scope of the invention as hereinafter claimed.

What is claimed is:

1. A pipe disassembling tool comprising:
a U-shaped body including a first arm and a second arm that can be outwardly wrenched relative to each other, each of the first arm and the second arm having a curved cutout defined in a free end thereof and facing each other;
a first curved pusher extending from the free end of the first arm and corresponding to the curved cutout in the first arm, the first curved pusher including two curved plates perpendicularly extending from the free end of the first arm and a slit defined between the two curved plates to allow the two curved plates be elastic deformed relative to each other; and
a second curved pusher extending from the free end of the second arm and corresponding to the curved cutout in the second arm, the second curved pusher including two curved plates perpendicularly extending from the free end of the second arm and a slit defined between the two curved plates of the second curved pusher to allow the two curved plates of the second curved pusher be elastic deformed relative to each other.

2. The pipe disassembling tool as claimed in claim 1, wherein the body comprises a spring portion formed on a middle portion thereof between the first arm and the second arm to make the first arm and the second be easily outwardly wrenched relative to each other.

3. The pipe disassembling tool as claimed in claim 1, wherein a free end of each of the curved plates of the first curved pusher and the second curved pusher inwardly and obliquely extends such that the first curved pusher and the second curved pusher are tapered for a convenient operation.

4. The pipe disassembling tool as claimed in claim 2, wherein a free end of each of the curved plates of the first curved pusher and the second curved pusher inwardly and obliquely extends such that the first curved pusher and the second curved pusher are tapered for a convenient operation.
